(19) United States
(12) Patent Application Publication
(10) Pub. No.: US 2014/0021317 A1
(43) Pub. Date: Jan. 23, 2014

(54) SUPPORT DEVICE INCLUDING TRAY FOR SUPPORTING OPTICAL ELEMENTS

(71) Applicant: CHENG-SHIUN WU, Tu-Cheng (TW)

(72) Inventor: CHENG-SHIUN WU, Tu-Cheng (TW)

(21) Appl. No.: 13/651,658

(22) Filed: Oct. 15, 2012

(30) Foreign Application Priority Data
Jul. 20, 2012 (TW) 101126398

(51) Int. Cl. F16M 13/00

(52) U.S. Cl. 248/346.03

(57) ABSTRACT

A support device includes a base plate and a tray. The tray defines positioning holes. The support device further includes positioning rods extending from the base plate, bottom magnets defining bottom holes, and upper magnets defining upper holes. The positioning rods extend through the bottom holes, the positioning holes and the upper holes in sequence. The bottom magnets separate the tray from the base plate.

### BACKGROUND

1. Technical Field

The present disclosure relates to support devices and, particularly to a support device for supporting optical elements.

2. Description of Related Art

Optical elements, such as optical lenses and optical filters, are usually carried by a tray. The tray is placed on a platform. When assembling, a suction device sucks the optical element from the tray and put the optical element into a barrel. Yet, the surface of the tray is usually uneven and cannot be placed on the platform horizontally, which may prevent the suction device from sucking the optical elements.

Therefore, it is desired to provide a support device which can overcome the above-mentioned problems.

### BRIEF DESCRIPTION OF THE DRAWINGS

FIG. 1 is a schematic, isometric view of a support device according to an exemplary embodiment.

FIG. 2 is an exploded view of the support device of FIG. 1.

### DETAILED DESCRIPTION

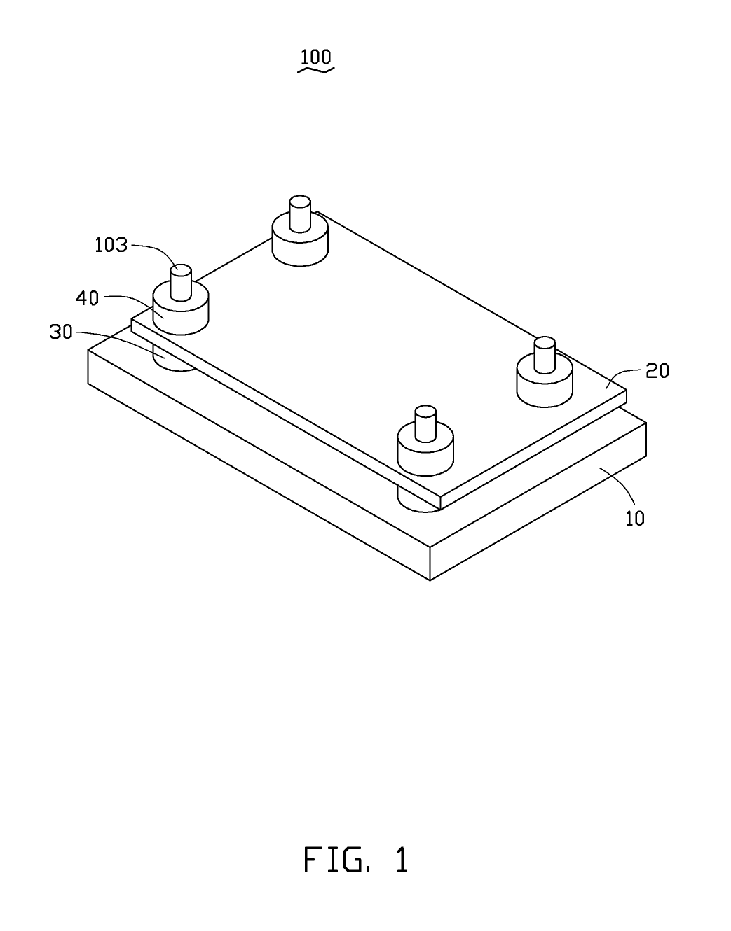

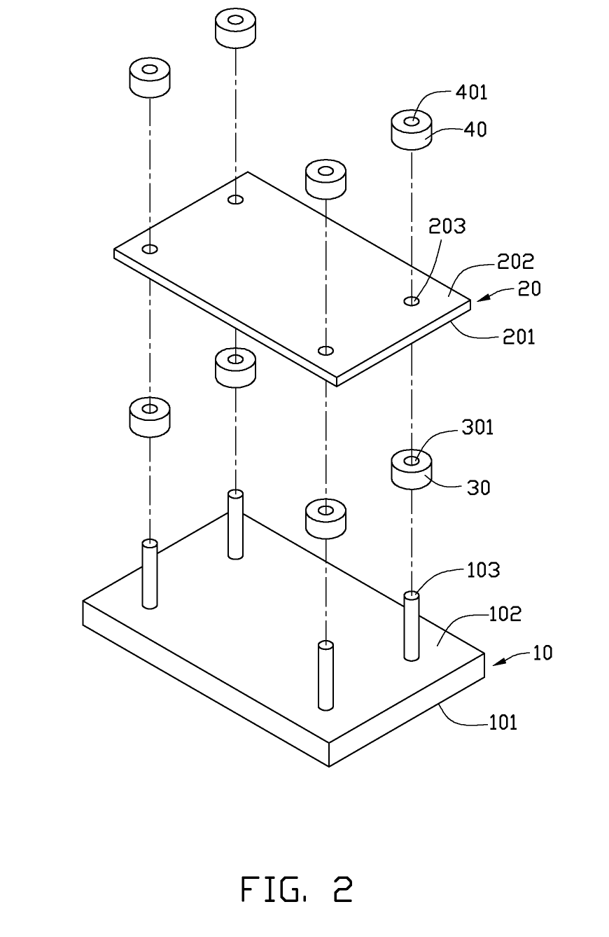

FIGS. 1 and 2 show a support device 100 according to an exemplary embodiment. The support device 100 includes a base plate 10, a tray 20, a number of bottom magnets 30, and a number of upper magnets 40.

The base plate 10 is rectangular. The base plate 10 includes a first surface 101 and a second surface 102. The second surface 102 is opposite to the first surface 101. The base plate 10 is put on a platform (not shown). The first surface 101 contacts the platform. A number of positioning rods 103 extend perpendicularly from the second surface 102. In the embodiment, four positioning rods 103 are positioned on four corners of the second surface 102 respectively.

The tray 20 is configured for carrying optical components (not shown). The tray 20 includes a third surface 201 and a fourth surface 202. The third surface 201 is opposite to the fourth surface 202. The tray 20 defines a number of positioning holes 203 corresponding to the positioning rods 103 respectively. The positioning holes 203 extend from the third surface 201 to the fourth surface 202. The tray 20 further defines a number of receiving grooves (not shown) for receiving the optical elements. The third surface 201 and the fourth surface 202 are uneven surfaces because the existence of the receiving grooves.

The bottom magnets 30 and the upper magnets 40 are hollow cylinders. Each of the bottom magnets 30 defines a bottom hole 301. Each of the upper magnets 40 defines an upper hole 401.

The positioning rods 103 extend through the bottom holes 301, the positioning holes 203, and the upper holes 401 in sequence. The bottom magnets 30 are sandwiched between the base plate 10 and the tray 20, and contact the second surface 102 and the third surface 201 respectively. The bottom magnets 30 separate the tray 20 from the base plate 10. The upper magnets 40 contact the fourth surface 202. The bottom magnets 30 and the upper magnets 40 attract each other to fix the tray 20.

The tray 20 is separated from the base plate 10, thus, although the tray 20 has uneven surfaces, the tray 20 can be put horizontally. In this way, the suction device can suck the optical elements carried on the tray 20 conveniently.

It is to be understood, however, that even though numerous characteristics and advantages of the present embodiments have been set forth in the foregoing description, together with details of the structures and functions of the embodiments, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A support device, comprising:
a base plate;
a plurality of positioning rods extending from the base plate;
a plurality of bottom magnets, each of the bottom magnets defining a bottom hole;
a tray defining a plurality of positioning holes; and
a plurality of upper magnets, each of the upper magnets defining an upper hole; wherein each of the positioning rods extends through a respective one of the bottom holes, a respective one of the positioning holes, and a respective one of the upper holes in sequence, the bottom magnets separate the tray from the base plate.

2. The support device of claim 1, wherein the base plate comprises a first surface and a second surface opposite to the first surface, the second surface faces the tray, and the positioning rods extend from the second surface.

3. The support device of claim 2, wherein the positioning rods perpendicularly extend from the second surface.

4. The support device of claim 1, wherein the bottom magnets and the upper magnets are hollow cylinders.

5. The support device of claim 1, wherein the tray comprises a third surface and a fourth surface opposite to the third surface, the third surface faces the base plate, and the bottom magnets touch the third surface and the base plate, and the upper magnets are positioned on the fourth surface.
